(19) United States
(12) Patent Application Publication
(10) Pub. No.: US 2026/0336398 A1
(43) Pub. Date: Oct. 29, 2026

(54) DISPLAY DEVICE FOR A VEHICLE

(71) Applicant: BHTC GmbH, Lippstadt (DE)

(72) Inventors: Tuomas SIEKKINEN, Tampere (FI); Pasi KEMPPINEN, Tampere (FI); Ville-Veikko PUOLIMATKA, Siivikkala (FI); Pyry VÄLIMÄKI, Tampere (FI); Santeri SINKKONEN, Tampere (FI)

(21) Appl. No.: 19/111,027

(22) PCT Filed: Sep. 5, 2023
(86) PCT No.: PCT/EP2023/074241

§ 371 Date: Mar. 12, 2025

(30) Foreign Application Priority Data
Sep. 20, 2022 (DE) 10 2022 124 030.4

(51) Int. Cl. B60K 35/10; B60K 35/22

(52) U.S. Cl. CPC B60K 35/10; B60K 35/22; B60K 2360/126; B60K 2360/128; B60K 2360/332; B60K 2360/333; B60K 2360/336; B60K 2360/343

(57) ABSTRACT

The display device for a vehicle comprises a display having a display surface which is backlit by scattered light, so that the information is visible. However, in those areas in which one or more manual operating elements are arranged on the display surface, the display is backlit with bundled light which is scattered at the front side of each operating element as it emerges from a display area. This allows the information in the display area of the display surface located behind the operating element to be made visible without impairments on the front side of the operating element or of each operating element, respectively.

The invention relates to a display device for a vehicle and, in particular, to a display device for a vehicle in which an operating element in the form of, for example, a rotary adjuster or rotary/push adjuster, adapted to be operated manually, is arranged on the display surface.

Display devices for vehicles with the additional possibility of being able to enter commands by touching the display surface, i.e. ultimately touchscreens, have proven themselves as operating concepts for vehicles. Nevertheless, over time it has become apparent that entering commands using rotary knobs or rotary/push adjusters is sometimes more convenient, which ultimately depends on the application.

For this reason, it has already been used in the past to arrange rotary adjusters or rotary/push adjusters on touchscreens (see, for example, WO-A-2018/137944 or WO-A-2018/114138).

DE-A-10 2018 118 839 discloses a rotary/push adjuster on a backlit display, which is configured as a ring within which the information shown on the display is visible.

DE-A-10 2015 015 308 describes an operating element with an integrated display, wherein the display is backlit by means of directional light.

If such operating elements arranged on display surfaces of display devices are to have a display for their part, this display is typically integrated into the operating element as an independent display unit. However, since the surface on which the operating element is arranged is itself configured as a display surface, it is also possible to use the display surface itself as the display surface of the operating element in the area in which the operating element is arranged. This means that the operating element has a “transparent” area through which the information on the display surface of the display is visible.

However, it should be noted that the visible display surface of the operating element protrudes from the display surface of the display by the height of the operating element. The luminous intensity with which the backlit alphanumeric or graphic information is visible in the area of the display surface of the display, on which the operating element is located, on its front side is thus reduced and limited to a narrow viewing angle range.

It is an object of the invention to provide a display device for a vehicle in which an operating element with a display area arranged at a distance from the display is arranged on a display surface of the display, within which alphanumeric or graphic information shown on the display surface of the display can be displayed with sufficient luminous intensity.

The object of the invention is achieved with the invention proposing a display device for a vehicle, the display device being provided with
a display having a display surface for displaying (graphic and/or alphanumeric or other character) information,
an operating element arranged on the display, which can be operated manually,
wherein the operating element has a front side arranged at a distance from the display surface of the display with at least one display area for displaying information in the display area of the display surface of the display aligned with the display area of the front wall of the operating element, and
a backlighting unit for backlighting the display,
wherein the backlighting unit has a light guide plate with a light exit side facing the display and with a rear side facing away from the display and backlighting light sources feeding backlight into the light guide plate,
wherein the light guide plate has a light transmission area for collimated light arranged between its rear side and its light exit side, which is aligned with the display area of the front side of the operating element,
wherein the backlighting unit further comprises at least one further light source for collimated light which passes through the light transmission area of the light guide plate and emerges at the light exit side of the light guide plate and, after passing through the display area of the display surface of the display which is aligned with the display area of the operating element, backlights the information displayed in this area and makes it visible in the display area of the operating element,
wherein a diffuser for diffusing the collimated light for the display area of the operating element is arranged in the operating element between its display area and the display area of the display surface of the display which is aligned therewith.

The display device according to the invention comprises a display having a display surface for displaying information, for example graphic and/or alphanumeric information or character information. An operating element in the form of a rotary knob, a rotary/push adjuster or one or more operating buttons, for example, adapted to be operated manually, is arranged on the display. The operating element itself has a front side arranged at a distance from the display surface of the display, within which there is at least one display area in which information is displayed that is visible in the display area of the display surface of the display with which the display area on the front side of the operating element is aligned (i.e. lies on a common optical axis).

The display is backlit by means of a backlighting unit which has a light guide plate or a light guide foil with a light exit side facing the display and a rear side facing away therefrom. Furthermore, the backlighting unit also includes backlight sources that feed backlight into the light guide plate or light guide foil and, if necessary, a reflector layer on the rear side of the light guide that faces away from its light exit side. The light guide plate (when the term light guide or light guide plate is used in the following, this also refers to the configuration of the light guide as a foil) has a light transmission area for collimated light between its rear side and its light exit side, said light transmission area being aligned with the display area on the front side of the operating element in accordance with the invention, i.e. it lies on a common optical axis with said display area. The backlighting unit is additionally provided with at least one further light source which, unlike the aforementioned backlighting light sources, emits collimated light which passes through the light transmission area of the light guide plate and emerges on the light exit side of the light guide plate and, after passing through the display area of the display surface of the display which is aligned with the display area of the operating element, backlights the information displayed in this area and makes it visible in the display area of the operating element, more light-intensive than the backlight emerging from the light exit side of the light guide could achieve if it also emerged from the light exit side in the area of the light transmission area of the light guide for collimated light. To ensure that the information visible there is also visible over the widest possible viewing angle range, a diffuser for scattering the collimated light for the display area of the operating element is located in the operating element between its display area and the display area of the display surface of the display that is aligned therewith.

According to the invention, the light guide of the backlighting unit is not only used for large-area and homogeneous backlighting of the display surface of the display, but the light guide plate is “transilluminated” in at least one light transmission area by collimated light, which is thus bundled and much more strongly focused than in the remaining area of the display surface on that display area of the display surface of the display which is aligned with the display area on the front side of the operating element and thus lies on a common axis with the light transmission area of the light guide plate. To ensure that this collimated light is now emitted from the display area on the front side of the operating element over a comparatively large viewing angle range, a diffuser element for diffusing the collimated backlight for said display area is located in the operating element, preferably close to the front side.

This backlighting concept ensures that both the display surface of the display outside the at least one operating element arranged on the display is backlit homogeneously and brightly, but also that the display area of the at least one operating element arranged above the display surface of the display is sufficiently backlit and can be viewed within a wide viewing angle range.

As already described above, the operating element can be configured as at least one button and/or at least one rotary adjuster and/or at least one rotary/push adjuster. In general, the operating element can have a design for haptic feedback (passive or active). If the operating element is equipped with adjustable elements, this adjustment can be made by latching.

The at least one light source for collimated light expediently has at least one illuminant, in particular at least one LED, as well as a reflector and/or a lens.

The light transmission area of the light guide plate for collimated light can expediently be configured as a light guide or as a passage opening of the light guide plate or as an integral part of the light guide plate.

In an advantageous embodiment of the invention, it may be provided that the at least one light source for collimated light is arranged facing the rear side of the light guide plate and the light transmission area of the light guide plate for collimated light. Said collimated light therefore enters the light transmission area of the light guide plate as a “direct backlight”, so to speak.

Alternatively, it may be provided that the light source for collimated light comprises at least one illuminant, in particular at least one LED, and a light guide which is provided with a light exit end which is arranged opposite the light transmission area of the light guide plate for collimated light or in the light transmission area of the light guide plate for collimated light, and with a light entry end which is arranged outside the rear side of the light guide plate. The light source or the light sources for collimated light therefore irradiate into a light guide whose light exit end is either arranged in a passage opening of the light guide plate or which is arranged opposite the light transmission area of the light guide plate.

The display concept according to the invention can also be realized several times in a display device, so that such a display device is provided with several operating elements and several display areas on the display surface which are each aligned with their display areas and to each of which a light transmission area for collimated light is assigned in the light guide plate of the backlighting unit, wherein the backlighting unit has at least one light source for collimated light for each light transmission area or at least one light source for collimated light common to all light transmission areas, from which light guides extend to the light transmission areas of the light guide plate.

In a further expedient embodiment of the invention, it may be provided that the at least one light source for collimated light comprises a laser diode and, in particular, an RGB laser diode arrangement.

Advantageously, the light sources for the backlight are arranged opposite the rear side of the light guide plate and/or a side edge area of the light guide plate.

The backlighting light sources are typically configured as LEDs.

The invention is described in more detail below with reference to an exemplary embodiment and with reference to the drawing. In detail, the Figures show:

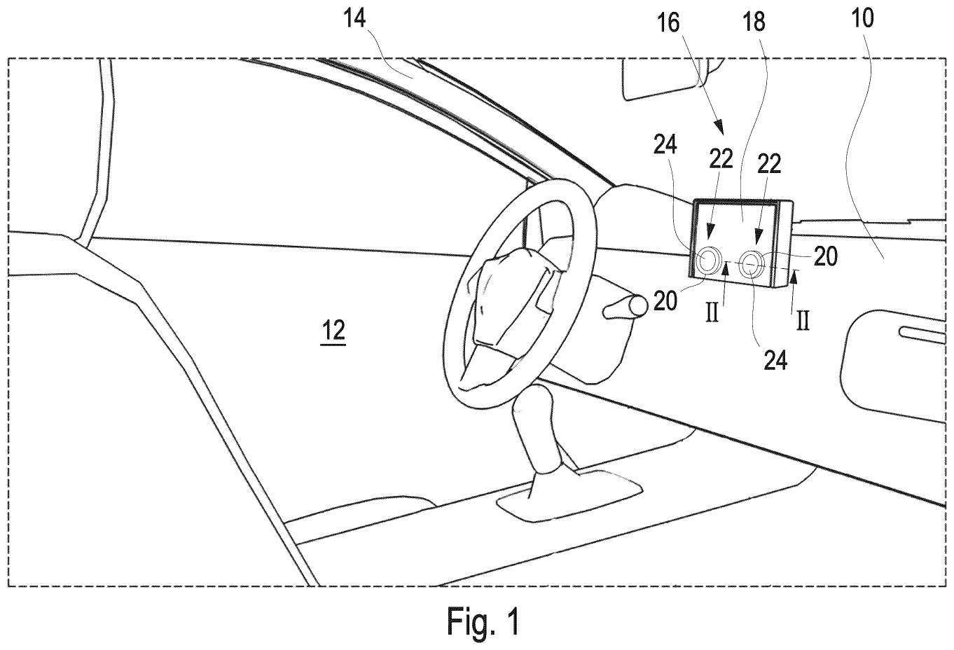

FIG. 1 a view of the instrument panel of a vehicle with a display device according to the invention, which is also used as an operating device,

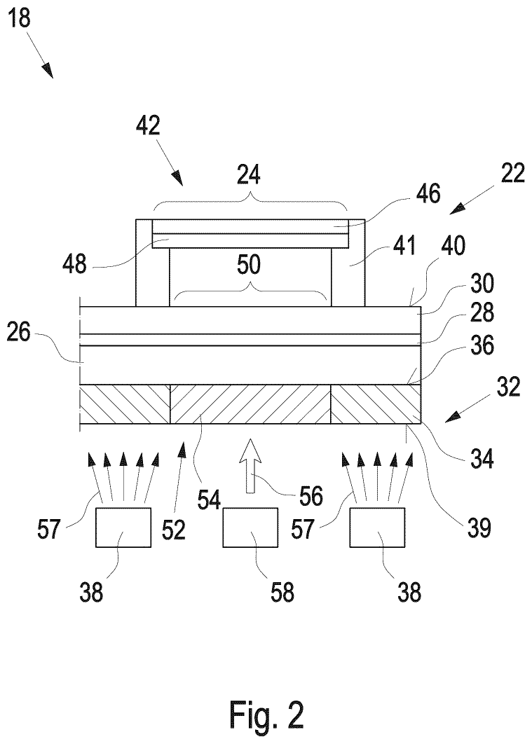

FIG. 2 a section along line II-II through the area at the bottom right of the display device, as shown in FIG. 1,

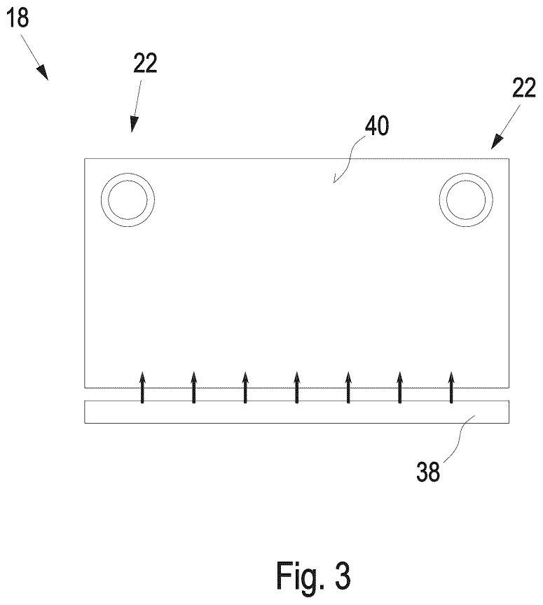

FIG. 3 an example for feeding the backlight for the areas of the display surface on which there is no additional manual operating element, and

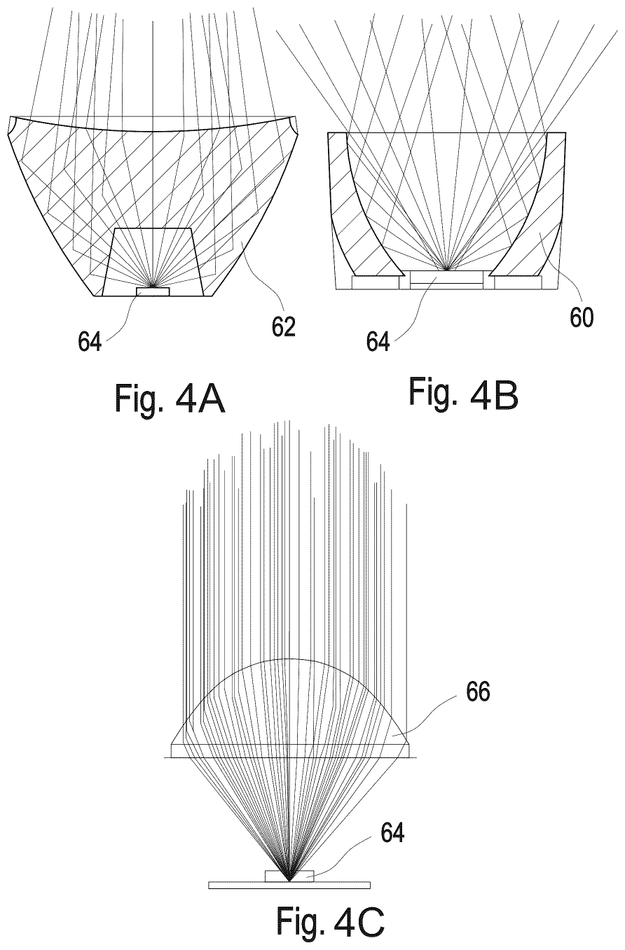

FIGS. 4a to 4c three examples of the design of light sources for emitting substantially collimated or bundled light for backlighting the display area of the display surface of the display device on which the manual operating element in the form of a rotary adjuster is arranged,

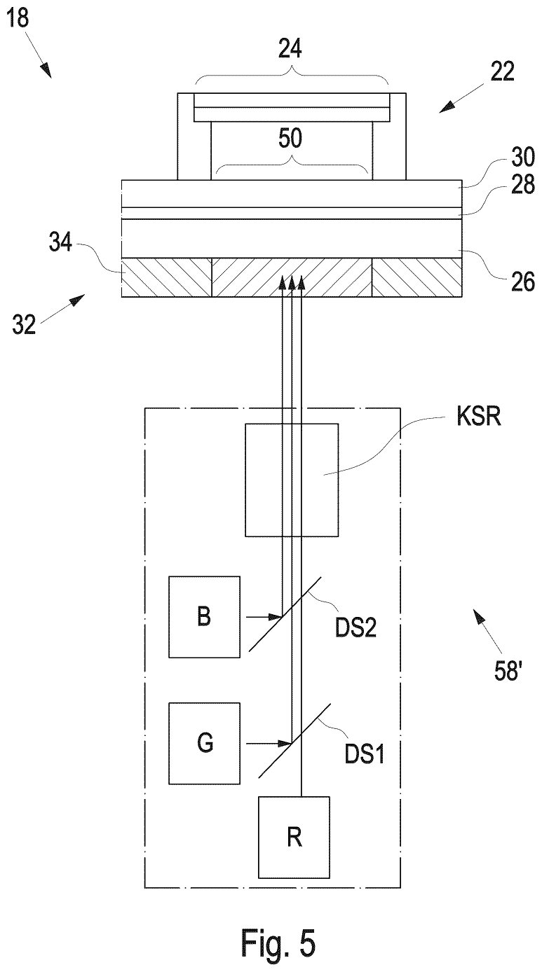

FIG. 5 an example of feeding RGB collimation light into the area of the light guide aligned with the manual operating element, in which the light guide has its light transmission area for collimated light.

FIG. 1 shows a perspective view of the instrument panel 10 in the interior 12 of a vehicle 14, which in this exemplary embodiment is provided with an operating device 16 having a display device 18 with, in this exemplary embodiment, two operating elements 22 in the form of rotary adjuster 20 adapted to be manually operated. The two operating elements 22 have display areas 24 in which the (alphanumeric or graphic or other character) information displayed in the area of the display device 18 below the operating elements 22 is visible.

The components of the display device 18 that are mainly relevant to the invention are shown in FIG. 2. Accordingly, the display device 18 comprises a display 26 in the form of typically an LCD display having a touch panel 28 as a touch sensor system (not necessarily required) and a cover plate 30. A backlighting unit 32 is used to backlight the display 26, which has a light guide plate 34 with a light exit side 36 facing the display 26 and backlighting light sources 38. In this exemplary embodiment, the backlighting light sources 38 are located facing the rear side 39 of the light guide plate 34.

The display surface 40 of the display device 18, on which the operating element 22 is arranged, is located on the cover plate 30, so to speak. Said operating element is configured as a (hollow) ring 41 whose front end facing away from the display surface 40, i.e. its front side 42, comprises the display area 24, which is configured as a cover plate 46, with a diffuser 48 located inside the ring 41.

As can be seen from FIG. 2, the operating element 22 is located in a display area 50 of the display surface 40 of the display device 18, which is aligned with an area 52 of the light guide plate 34, wherein in this area 52 of the light guide plate 34 the latter is provided with a light transmission area 54 for collimated light. The collimated light 56 or, in general terms, the light bundled with respect to the backlighting light sources 38 is indicated by the arrow in FIG. 2. The light source 58 for this collimated light is, for example, a light source as shown in FIGS. 4 and 5, which will be discussed later. In contrast, the backlight of the backlighting light sources 38 is “fanned out” (indicated by the arrows 57). Typically, between the light exit side 36 of the light guide plate 34 and the display 26 there is also a diffuser layer for equalizing the backlight, which should have a recess in its area aligned with the light transmission area 54 so that the collimated light is only scattered by the diffuser 48 of the operating element 22 after passing the display 26.

The peculiarity of the concept presented here is that the bundled light 56 causes the information in the display area 50 of the display surface 40 of the display device 18, since it is backlit by the collimated or bundled light of the collimation light source 58, to be displayed in the display area 24 on the front side 42 of the operating element 22, where the light is scattered by the diffuser 48 so that the information visible on the front side 42 of the operating element 22 can be viewed over a wide viewing angle range.

FIG. 3 shows an alternative for the backlighting of the display surface 40 of the display device 18. In this exemplary embodiment, the backlighting is provided by backlighting light sources 38, which irradiate laterally into the light guide plate 34 not shown in FIG. 3. It should be noted here that light transmission areas 54 of the light guide plate 34 (see, for example, FIG. 2) can lead to a shadow effect of the backlight irradiated laterally. However, the light guide plate 34 is typically backed with a reflective foil, so that backlight can ultimately also reach the supposed “shadow areas” of the operating elements 22 by internal reflection and reflection on the reflective foil.

FIGS. 4a to 4c show three exemplary embodiments for the configuration of the collimation light source 58. The collimation light source can be provided with a reflector 60, as shown in FIG. 4b. Alternatively, as shown in FIG. 4a, a TIR lens 62, i.e. a lens with total internal reflection, can be used. In both cases, the light from an LED light source 64, for example, is emitted in a directed manner.

As an alternative to the approaches shown in FIGS. 4a and 4b, an aspherical lens 66 can also be used, as shown in FIG. 4c. Finally, a further variant of the configuration of the collimation light source 58 relates to the use of a Fresnel lens.

Another possibility for backlighting the display 26 in the area 50 of the display surface 40 in which the operating element 22 is located is to use laser light sources (for example laser LEDs). The use of an RGB laser enables the illustration of volumetric holograms to visualize 3D representations.

Finally, the collimated light in the display area 50 of the display surface 40 of the display device 18 may also be obtained by subpixel microlenses arranged in this area. In this exemplary embodiment, it is then not necessarily required for collimated light to emerge in that area of the light exit side 36 of the light guide plate 34 which lies on a common optical axis with the display area 50 of the display surface 40 of the display device 18.

As a further possibility of feeding collimated light into a light transmission area 54 of the light guide plate 34, reference is made to the use of light guides, the ends of which are either arranged opposite a light transmission area 54 or several light transmission areas 54 of the light guide plate 34 or are inserted in passage openings of the light guide plate 34, wherein the light entry ends of the light guide or light guides receive collimated light from a collimation light source 58 which is arranged remotely and in particular not behind the light guide plate 34.

FIG. 5 shows an exemplary embodiment of the light source 58′ for collimated light. If parts of the display device 18 are shown in the illustration according to FIG. 5, they are provided with the same reference numerals as in FIG. 2.

The light source 58′ is configured as a collimated laser light source and has three (e.g. semiconductor) laser light sources R, G, B for colored laser light. The light beams from the three laser light sources are directed in parallel via dichroic mirrors DS1 and DS2 and pass through an optical element KSR for collimation and speckle reduction.

The peculiarity of the display device according to the invention is to be seen in the fact that in those areas of the display surface in which there is or are no operating element(s), the backlight, as is usually the case with backlit display devices, emerges comparatively undirected and thus scattered, whereas the backlight in the areas of the display device occupied by the manual operating element(s) emerges in a significantly more directed and in particular bundled manner, only to be scattered via a diffuser arranged at a distance from the display surface, namely on the front side of the operating element or the front sides of the operating elements. This concept can be used for display devices with one or more operating elements, wherein the operating elements can have different heights. The light guide plate can be integrally formed; the light transmission area or areas can be made of the same or a different light guide material as the rest of the light guide plate.

### LIST OF REFERENCE NUMERALS

2 exemplary embodiment
10 instrument panel
12 interior
14 vehicle
16 operating device
18 display device
20 rotary adjuster
22 operating element
24 display area on front side of operating element
26 display
28 touch panel
30 cover plate
32 backlighting unit
34. light guide plate
36 light exit side
38 backlighting light sources
39 rear side of light guide plate
40 display surface of display
41 ring of operating element
42 front side of operating element
46 cover plate
48 diffuser
50 display area on display surface of display
52 area
54 light transmission area
56 bundled light
58 collimation light source
58 collimation light source
60 reflector
62 TIR lens
64 LED light source
66 aspherical lens
DS1 mirror
DS2 mirror
KSR optical element for collimation and speckle reduction
B laser
G laser
R laser

1. A display device for a vehicle, comprising
a display having a display surface for displaying information,
an operating element arranged on the display, which can be operated manually,
wherein the operating element has a front side arranged at a distance from the display surface of the display with at least one display area for displaying information in the display area of the display surface of the display aligned with the display area of the front wall of the operating element, and
a backlighting unit for backlighting the display,
wherein the backlighting unit has a light guide plate with a light exit side facing the display and with a rear side facing away from the display and backlighting light sources feeding backlight into the light guide plate,
wherein the light guide plate has a light transmission area for collimated light arranged between its rear side and its light exit side, which area is aligned with the display area of the front side of the operating element,
wherein the backlighting unit further comprises at least one further light source for collimated light which passes through the light transmission area of the light guide plate and emerges at the light exit side of the light guide plate and, after passing through the display area of the display surface of the display which is aligned with the display area of the operating element, backlights the information displayed in this area and makes it visible in the display area of the operating element,
wherein a diffuser for diffusing the collimated light for the display area of the operating element is arranged in the operating element between its display area and the display area of the display surface of the display which is aligned therewith.

2. The display device according to claim 1, wherein the operating element is configured as at least one button and/or at least one rotary adjuster and/or at least one rotary/push adjuster.

3. The display device according to claim 1, wherein the at least one light source for collimated light has at least one illuminant as well as a reflector and/or a lens.

4. The display device according to claim 1, wherein the light transmission area of the light guide plate for collimated light is configured as a light guide or as a passage opening of the light guide plate.

5. The display device according to claim 1, wherein the at least one light source for collimated light is arranged facing the rear side of the light guide plate and the light transmission area of the light guide plate for collimated light.

6. The display device according to claim 1, wherein the light source for collimated light comprises at least one illuminant and a light guide which is provided with a light exit end which is arranged opposite the light transmission area of the light guide plate for collimated light or in the light transmission area of the light guide plate for collimated light, and with a light entry end which is arranged outside the rear side of the light guide plate.

7. The display device according to claim 6, characterized by several operating elements and several display areas on the display surface of the display, each of which is aligned with its display areas and to which a respective light transmission area for collimated light is assigned in the light guide plate of the backlighting unit, wherein the backlighting unit has at least one light source for collimated light for each light transmission area or at least one light source for collimated light common to all light transmission areas, from which light guides extend to the light transmission areas of the light guide plate.

8. The display device according to claim 1, wherein the at least one light source for collimated light comprises a laser diode.

9. The display device according to claim 1, wherein the light sources are arranged opposite the rear side of the light guide plate and/or opposite a side edge area of the light guide plate.

10. The display device according to claim 1, wherein the backlighting light sources comprise LEDs.

11. The display device according to claim 1, wherein the at least one light source for collimated light has at least one LED.

12. The display device according to claim 1, wherein the at least one light source for collimated light comprises an RGB laser diode arrangement.

13. The display device according to claim 3, wherein the at least one illuminant comprises at least one LED.

14. The display device according to claim 3, wherein the light transmission area of the light guide plate for collimated light is configured as a light guide or as a passage opening of the light guide plate.

15. The display device according to claim 14, wherein the at least one light source for collimated light is arranged facing the rear side of the light guide plate and the light transmission area of the light guide plate for collimated light.

16. The display device according to claim 6, wherein the at least one illuminant comprises at least one LED.

17. The display device according to claim 6, wherein the at least one light source for collimated light comprises a laser diode.

18. The display device according to claim 6, wherein the at least one light source for collimated light comprises an RGB laser diode arrangement.

19. The display device according to claim 6, wherein the light sources are arranged opposite the rear side of the light guide plate and/or opposite a side edge area of the light guide plate.

20. The display device according to claim 6, wherein the backlighting light sources comprise LEDs.
